(19) United States
(12) Patent Application Publication
(10) Pub. No.: US 2014/0324805 A1
(43) Pub. Date: Oct. 30, 2014

(54) USER-GENERATED CONTENT OF ENTITY-SPECIFIC SEARCH

(71) Applicant: MICROSOFT CORPORATION, Redmond, WA (US)

(72) Inventors: Sparsh Agarwal, Bellevue, WA (US); Loic Deniel, Bellevue, WA (US); Mayank Jain, Redmond, WA (US); Jeff Winter, Seattle, WA (US)

(73) Assignee: Microsoft Corporation, Redmond, WA (US)

(21) Appl. No.: 13/873,619

(22) Filed: Apr. 30, 2013

(51) Int. Cl. G06F 17/30

(52) U.S. Cl. CPC G06F 17/30554
USPC 707/706

(57) ABSTRACT

Architecture that enables users to contribute their knowledge and add content to entities in a search context. The architecture provides the capability for users to add content to entities in a search context, display the knowledge assimilated from a user base for entities in a search context, validate (algorithmic, editorial or crowd-based) user-generated content to ensure correctness and filter spam, and rank the user-generated facts (whether algorithmic or crowd-sourced) to display most relevant facts in the user interface (as part of the user experience (UX)). To address user motivation and provide incentives, users can be given rewards (e.g., points, recognition, etc.) for a validated submission.

### BACKGROUND

Search engines rely on websites and data feeds to create an entity experience. However, the combined knowledge of millions of daily search users is far more exhaustive than what search engines can assimilate by simply crawling the web. Currently, there is no search engine that benefits from user knowledge, helps improve task completion, and enhances the entity experience in the context of search. One existing vendor uses a map-specific solution and not for entity based search (which is more broad and concerned with “knowledge” of the world beyond location-specific data).

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables users to contribute their knowledge and add content to entities in a search context. The architecture provides the capability for users to add content to entities in a search context, display the knowledge assimilated from a user base for entities in a search context, validate (editorial or crowd-based) user-generated content to ensure correctness and filter spam, and rank the user-generated facts (whether algorithmic or crowd-sourced) to display most relevant facts in the user interface (as part of the user experience (UX)).

When a search query returns a short summarization (a snapshot) of an entity, a user is presented with a user-generated content module that showcases facts (e.g., tips, trivia, knowledge, etc.) about the entity as submitted by other users. The user is provided the opportunity to contribute the user's knowledge via this module to the search engine's knowledge graph by completing a submission form. The form can be designed to request that the user provide a source of their information to assist the system (or other users, when using crowd-sourced verification) in verifying the user content.

Upon submission, content submitted by the user is channeled through a validation pipeline to ensure correctness and filter for spam. This validation pipeline can employ a combination of automated, crowd-sourced, and manual (judges) validation methods. Once the content is validated, the content can be stored in a database and exposed on the UX when a user searches for that entity on the search engine, as well as used to augment a central knowledge entity graph.

The architecture provides ranking in order to surface (present) the most interesting facts to users. In one implementation, after starting with a set of internally ranked facts, various facts about an entity can be presented to users to let the users “vote” for the most interesting facts. Users can be provided the ability to mark facts as inaccurate, offensive, or outdated, for example, in order to assist in improving fact ranking.

To address user motivation and provide incentives, users can be given bonus reward points for a validated submission. A third-party partner, for example, can utilize the architecture to promote products and services as the incentives for users to participate. In order to identify and reward users, users may be required to have a “signed-in” state on the search engine (e.g., by connecting a social network account and/or other online accounts).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system for user-generated content processing in accordance with the disclosed architecture.

FIG. 2 illustrates an alternative system for user-generated content processing in accordance with the disclosed architecture.

FIG. 3 illustrates a data workflow diagram for user-generated content on entity-specific search in accordance with the disclosed architecture.

FIG. 4 illustrates a user workflow diagram for inputting user-generated content as viewed generally in association with the user experience.

FIG. 5 illustrates a more detailed content submission form.

FIG. 6 illustrates a method in accordance with the disclosed architecture.

FIG. 7 illustrates an alternative method in accordance with the disclosed architecture.

FIG. 8 illustrates a block diagram of a computing system that executes user-generated content on entity-specific search in accordance with the disclosed architecture.

### DETAILED DESCRIPTION

The disclosed architecture enables users to contribute their knowledge and add content to entities in a search context. Any knowledge provided by the users is subject to validation to filter for correctness and spam. More specifically, the architecture provides the capability for users to add content to entities in a search context, display the knowledge assimilated from a user base for entities in a search context, validates (e.g., editorial or crowd-based) user-generated content to ensure correctness and filter spam, and rank the user-generated facts (whether algorithmic or crowd-sourced) to display most relevant facts in the user interface (as part of the user experience (UX)). If the user is known to be highly credible and factually correct most if not all of the time, the user may have developed a reputation such that the form may not request the various types of information requested of a first-time user or a probationary user, for example.

When a search query returns a short summarization (a snapshot) of an entity, a user is presented with a user-generated content module that showcases facts (e.g., tips, trivia, knowledge, etc.) about the entity as submitted by other users. The user is provided the opportunity to contribute the user's own knowledge via this module to the search engine's knowledge graph by completing a submission form. The form can be designed to request that the user provide a source of their information to assist the system (or other users, when using crowd-sourced verification) in verifying the user content.

In one implementation, the user-generated content is limited to less than two hundred characters. The size of the submitted content may need to be constrained in order for the content to be the most valuable in the context of a search engine entity pane display area on various devices/screens. This constraint will also help users condense facts to be more valuable to other users.

Upon submission, content submitted by the user is channeled through a validation pipeline to ensure correctness and filter for spam. This validation pipeline can employ a combination of automated, crowd-sourced, and manual (judges) validation methods. Once the content is validated, the content can be stored in a database and exposed on the UX when a user searches for that entity on the search engine, as well as used to augment a central knowledge entity graph.

As the amount of content (e.g., trivia, facts) grows for an entity, the architecture provides ranking in order to surface the most interesting facts to the user. In one implementation, after beginning with internally ranked facts, various facts about an entity can be presented to users to let the users “vote” for the most interesting facts. Users can be provided the ability to mark facts as inaccurate, offensive, or outdated, for example, in order to assist in improving fact ranking.

To address user motivation and provide incentives, users can be given bonus reward points for a validated submission. A third-party partner, for example, can utilize the architecture to promote products and services as the incentives for users to participate. In order to identify and reward users, users may be required to have a “signed-in” state on the search engine (e.g., by connecting a social network account and/or other online accounts).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

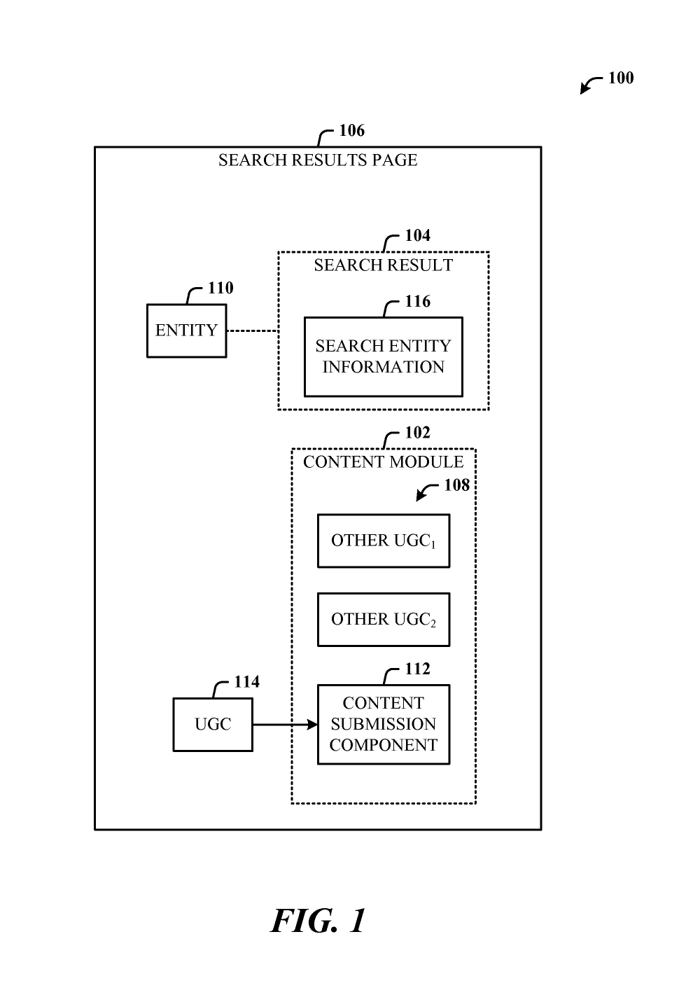

FIG. 1 illustrates a system 100 for user-generated content processing in accordance with the disclosed architecture. The system 100 can include a content module 102 presented in association with a search result 104 of a search results page 106. The content module 102 presents other user-generated content (other UGC) 108 related to a search entity 110. A content submission component 112 associated with the content module 102 enables input of user-generated content 114 related to the search entity.

When a search query returns a snapshot of information (the search entity information 116) of the entity 110 (e.g., Eiffel Tower, Seattle, etc.), a user is presented with the UGC content module 102. The content module 102 showcases facts (e.g., tips, trivia, knowledge, etc.) about the entity 110. The facts are submitted by search users.

The user is able to contribute the user's knowledge (the UGC 114) to the content module 102 by completing a submission form (the content submission component 112). In the form, users may be requested to provide a source of their information to assist in the verification of the UGC 114. The assistance can be provided to other users in the event of crowd-sourced verification.

In one implementation, the content module 102 enables the inclusion of short pieces of trivia that can be expressed in less than two hundred characters. The submission size is constrained in order for the trivia to be the most valuable in the context of a search engine entity pane display area on various devices/screens. The constraint also helps users condense facts which prove more valuable to the users.

The user-generated content 114 brings a value not found in other sources traditionally used by a search engine (e.g., feeds, crawling or social networks) as the user-generated content 114 is fresh, concise, and of nature that cannot be crawled or synthesized easily by algorithms.

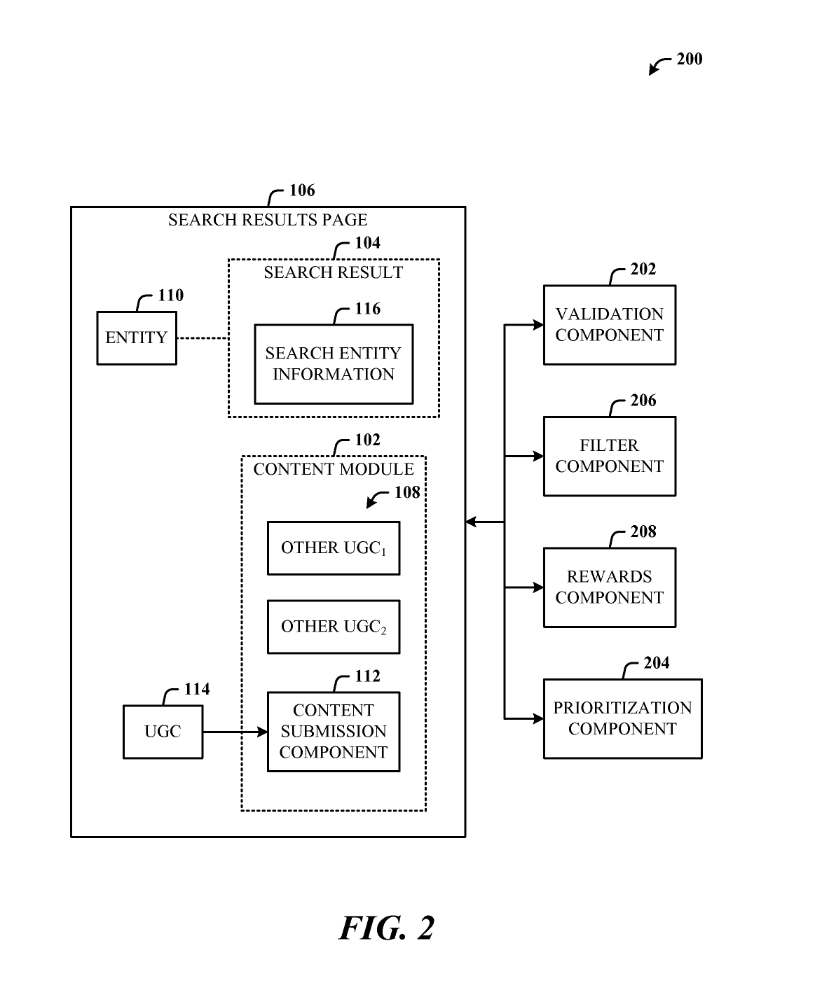

FIG. 2 illustrates an alternative system 200 for user-generated content processing in accordance with the disclosed architecture. The system 200 includes the system 100 of FIG. 1, as well as validation component 202, a prioritization component 204, a filter component 206, and a rewards component 208.

The validation component 202 validates the user-generated content 114 as to correctness submitted via the content submission component 112. The validated user-generated content 114 is stored in a verified data store for access and presentation in association with a search result of another search result page. The validation component 202 can validate the user-generated content 114 based on at least one of algorithmic validation, editorial input, or crowd-based input. The validation component 202 enables users to mark a fact as inaccurate, offensive, or outdated.

The prioritization component 204 prioritizes (e.g., ranks) candidate user-generated content according to prioritization criteria for presentation in the content module. The filter component 206 filters the user-generated content 114 to process for correctness and, unwanted content and spam. The rewards component 208 applies rewards related to the user-generated content 114 once it is published. The rewards component 208 can be associated with reward providers such as the search engine provider, one or more third-party vendors that offer vendor products, and/or a points system that once a minimum number of points is attained, can obtain a product from the vendor, or simply, recognition.

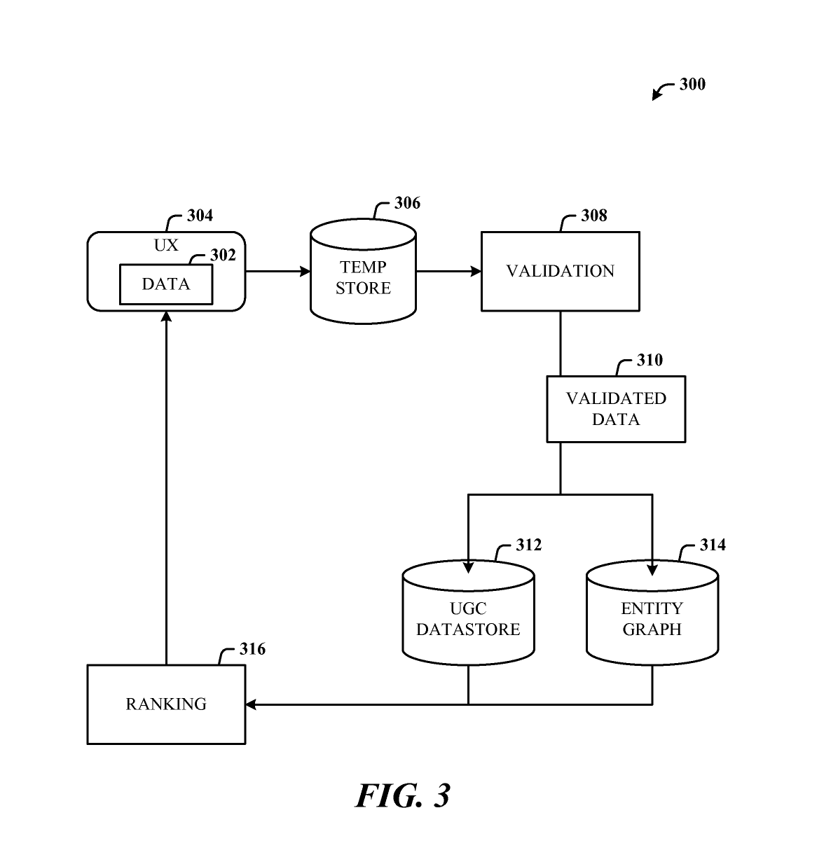

FIG. 3 illustrates a data workflow diagram 300 for user-generated content on entity-specific search in accordance with the disclosed architecture. The workflow begins by a user entering data 302 (e.g., the UGC 114) via a user experience (UX) 304. The data 304 is then sent to a temporary store 306. While in the temporary store 306, the data 302 is subjected to a validation process 308 (manual or automated, by the validation component 202) to create validated data 310. The validated data 310 is sent from the validation process 308 to a verified UGC data store 312. The validated data 310 may also be used to improve an entity graph 314 in the search engine. When a query is made in the search engine, user facts from the above data stores can be prioritized (e.g., ranked) by a ranking process 316. The top n ranked UGC (or facts), where n may be variable, are then selected and displayed to the user via the UX 304. Ranking can be accomplished alternatively, using a scoring algorithm that assigns scores to the user-generated content and based on which the top content can be selected for presentation.

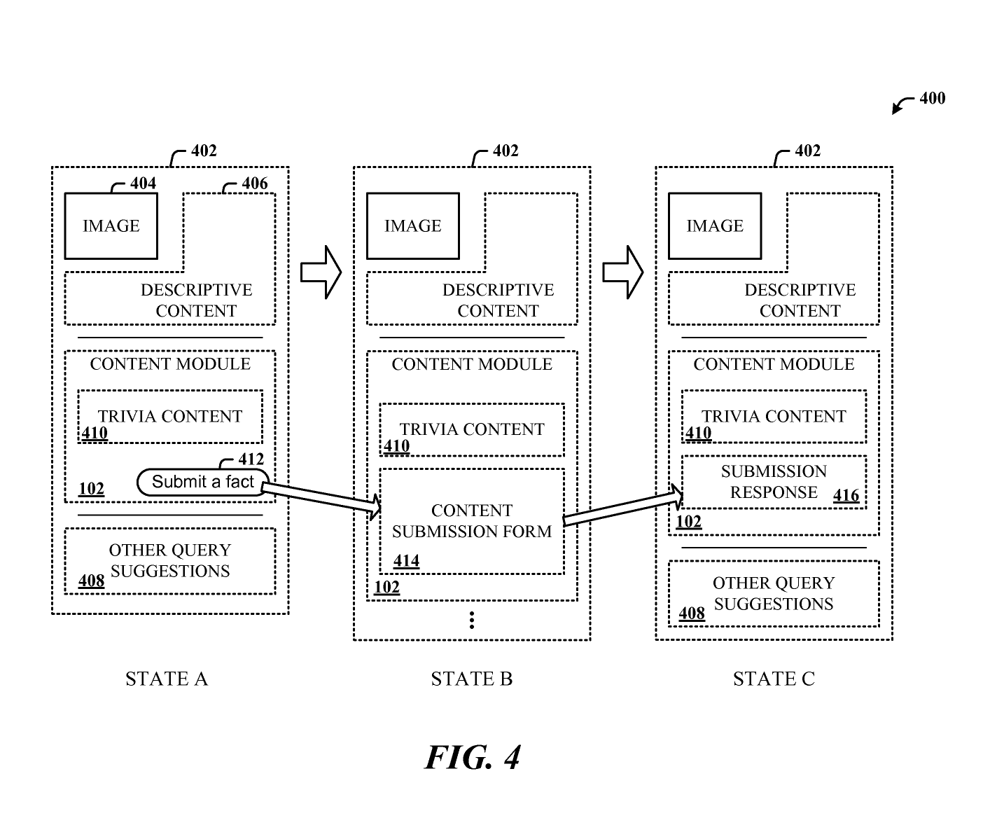

FIG. 4 illustrates a user workflow diagram 400 for inputting user-generated content as viewed generally in association with the user experience. A search result 402 is received as relates to an entity (e.g., the entity 110). In a state A, the result can comprise an image 404 and descriptive content 406 (collectively referred to as the search entity information 116). For example, the entity can be (the name of) a well-known athlete, where the image 404 is of the athlete and the descriptive content 406 includes the age, height, year the athlete became a professional, and a short biographical description of the athlete. The result 402 can further include other query suggestions 408 provided by other users.

In accordance with the disclosed architecture, the result 402 further includes the content module 102 that shows one or more facts or trivia content 410 (the other user-generated content 108) previously provided and validated from other users. The content module 102 can also include an interactive control 412 that when selected causes (or triggers) a fact entry submission form 414 to be presented, as shown in a state B. The content submission form 414 enables the input of specific user-generated content. In state C, once the user “submits” the completed form 414, a notification response 416 is presented that confirms receipt of the user-generated content and information about the reward program, and rewards for the specific user-generated content. Thereafter, the notification response 416 may also be removed from view, where the result 402 looks as in state A.

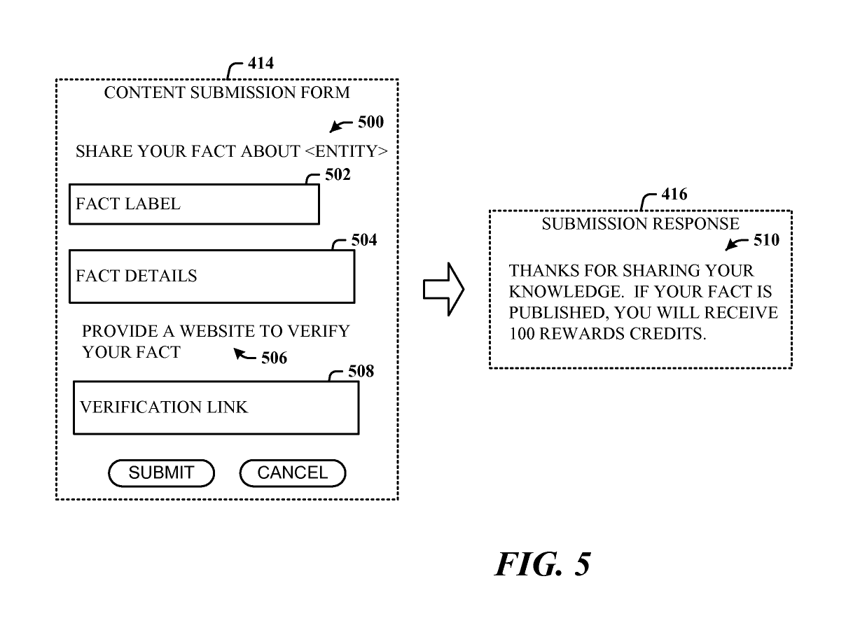

FIG. 5 illustrates a more detailed content submission form 414. The form 414 can include instructions to “share your fact about <entity>”. A fact label field 502 is presented in which the user can enter a fact label. A fact details field 504 enables user input of the fact details. This can be limited to a preset number of characters (e.g., no more than 200 characters), where the details are textual content. An optional second instruction 506 requests the user to provide the source link to the source of the user-generated content (fact details) for verification (validation). A verification link field 508 receives the source link information (e.g., http://sourcelink.com). Once the user submits the fact details, the submission response 416 can be presented, for example, “Thanks for sharing your knowledge. If your fact is published, you will receive 100 rewards credits.” Users can share on their social networks that they contributed knowledge to the search engine.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

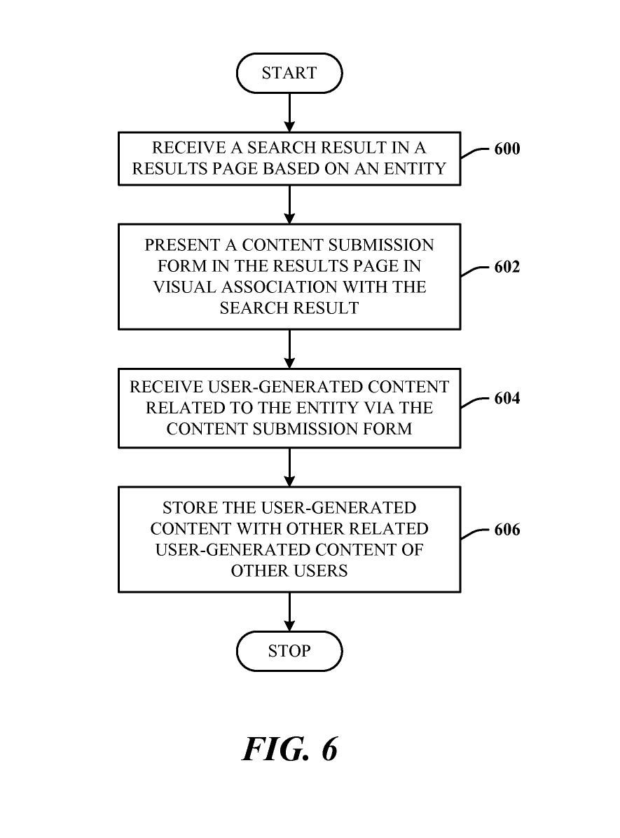

FIG. 6 illustrates a method in accordance with the disclosed architecture. At 600, a search result is received in a results page based on an entity. The search results are typically based on the query. Thus, the facts input by users may be related to the query. However, it can also be the case that the facts presented are more closely related to the search result to provide a more positive user experience.

At 602, a content submission form is presented in the results page in visual association with the search result. This form can be of any design that prompts the user to provide the minimum amount of information to validate the user input as to correctness. The capability of computing correctness can be, in a minimum implementation, obtaining the facts from a highly reliable source, such as a website, online encyclopedia, another user of significant knowledge and high credibility, online research and scientific sources, and so on.

At 604, user-generated content related to the entity is received via the content submission form. The submission form can be of several different and usable designs that can be selected for presentation to the user. If the user is known to be highly credible and factually correct most, if not all, of the time, the user may have developed a reputation such that the form/system may not request the various types of information requested of a first-time user or a probationary user, for example.

At 606, the user-generated content is stored with other related user-generated content of other users. This is for selecting the top candidate user-generated content. It can be the case that the user-generated content can be categorized such that only selected categories of content are accessed for the facts of a given search result. For example, there may be no need to process musical user-generated content when the search results are related to heavy machinery. Additionally, the categories of user-generated content can include different types of content, such as images, audio files, video files, and text for a specific category of entity. Thus, the selected candidate content for presentation can be a mix of the top ranked content, or limited to a specific type of content (e.g., only text, only images, only music files, etc.).

The method can further comprise validating correctness of the user-generated content. The correctness metric can be comprised of accuracy to the known facts, preciseness relative to the known facts, source of the user content, trustworthiness of the user, a continually evaluated (running) value of correctness metric of the user over time and across topics, and so on.

The method can further comprise presenting the user-generated content in association with the entity based on another search for that entity. The user-generated input is processed through the validation algorithm and is not a fact presented to the user who provided the content. Alternatively, however, it can be the case that the user supplied content can be immediately validated and presented to the user who supplied the content. Thus, it is processed for presentation to other users. It can also be the case that if the identity of the viewing user is known, the facts presented are unrelated to the search results but to the user interests. However, as a general proposition, the presented facts are related to the search result.

The method can further comprise ranking the user-generated content and other user-generated content for selection and presentation. Ranking is one technique for selecting candidate content to present as facts. Other techniques include the consideration of other feature information such as user identity, user location, popular content that may be related to the search result at the current time, and so on.

The method can further comprise augmenting an entity graph with the user-generated content. The addition of this user-generated content to the tree enhances the utility of the tree with relevant data.

The method can further comprise filtering out unwanted content. The unwanted content can be unrelated at all to the search result. The filtering criteria can be a predetermined set of criteria as an initial set, but then grow based on user-generated content for specific entities, for example.

The method can further comprise offering an enticement to enter the user-generated content and acting on the enticement based on validation of the user-generated content. An enticement can be simply that a specific user wants public recognition of the user's knowledge on specific subjects, as can be recognized by a class of user such as “expert” or “oracle”, for example. An enticement can also be to award points to the user based on publication of the user fact. An alternative can be to provide incremental points to the user based on content submission (e.g., one point), validation of the content (e.g., two points), and then publication of the content (e.g., five points).

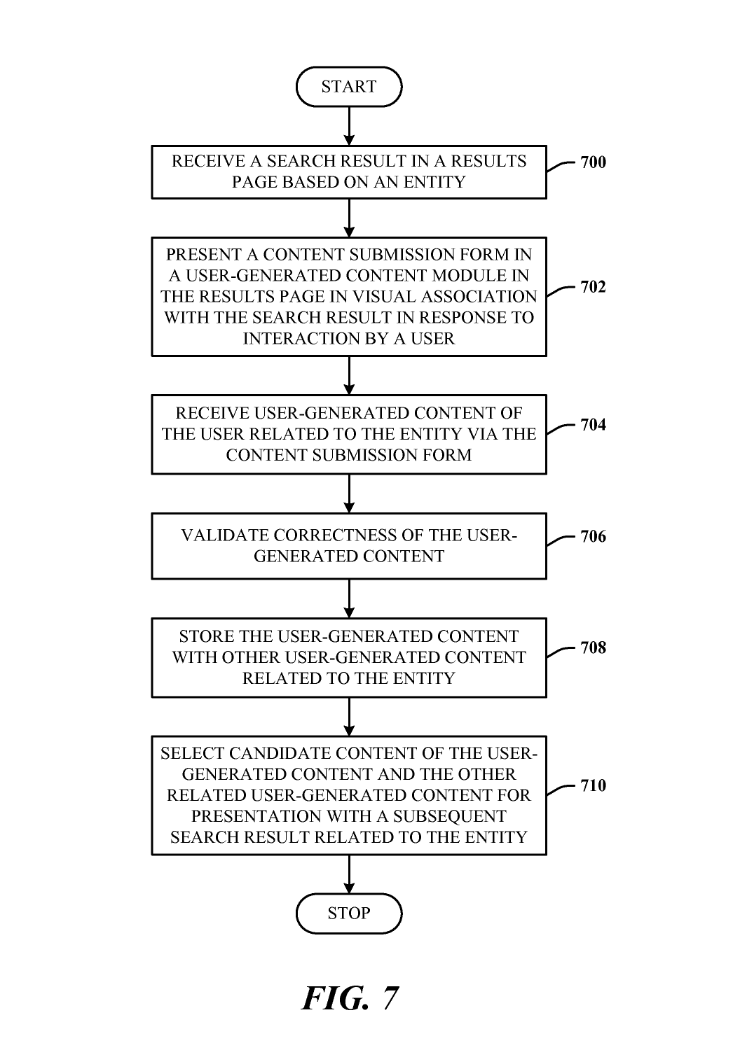

FIG. 7 illustrates an alternative method in accordance with the disclosed architecture. At 700, a search result is received in a results page based on an entity. The entity can be any topic of interest, whether about human interests (e.g., a person, people, etc.), and non-human interests (e.g., locations, animals, sites, etc.). At 702, a content submission form is presented in a user-generated content module in the results page in visual association with the search result, in response to interaction by a user. The search engine and/or a suitable component facilitate the insertion of the user-generated content module in association with any given search result.

It is to be understood, however, that there may be results for which the user-generated content section is not presented, and hence, the ability to receive user input via the content submission form. This can occur based on the history of the user computed to be providing unsuitable or untrustworthy input. This can be determined via the validation process. This is an intended consequence of intentionally not providing the user content submission form, while it can be the case that the unsuitable user is still presented with facts/content of other users. It can also be the case that no prior information has been presented for a given entity, and thus, no content is presented from other users. However, the user can still be presented with the user submission form to then provide a first set of content related to the entity for other users to see.

At 704, user-generated content of the user related to the entity is received via the content submission form. As previously described, the form can be designed to request any information needed to validate, and ultimately, provide factual information to other users viewing the same entity or a related similar entity. For example, the submission form can restrict the user input to textual content, and then limit textual content to a maximum number of characters (e.g., one hundred forty).

It can also be the case that the submission form (or the component that receives and processes the user input) restricts user input to only image content, or video content. In other words, the restricted content can be made to match the result type and/or the query type. If the user is searching for images, the submission form can restrict the user input to images, and so on.

At 706, correctness of the user-generated content is validated. The validation pipeline (process) uses at least the user-supplied link to compare the user input to the information provided by a document at the link source. To prevent linking back to unreliable sources, the linked source can also be vetted to ensure the user does not link to user-fabricated and unreliable content, in which case future links to the source results in rejection of the user input. It is to be appreciated that the user may simply have been mistaken. Should the user continue to be “mistaken” the user can be categorized as in a “probationary” status, and the ability to provide input can be limited or denied entirely. A notification as to the user being “on probation” can be presented to the user as well, thereby giving the user a chance to correct the behavior over time. Another embodiment reduces the enticement or rewards offered to such users based on the correctness of their input until such time they provide input that is validated to a positive end.

At 708, the user-generated content is stored with other user-generated content related to the entity. The user-generated content (input) is not immediately presented back to the user, but validated and stored with the user-generated content of users. Accordingly, the store(s) of user-generated content can be processed in any number of ways to provide the desired fact information. Thus, selection for fact information to be presented can be obtained from a ranked set of the user-generated content. In another embodiment, the user-generated content can be grouped by content type (e.g., text, image, video, audio, etc.), and then a predefined number of the top single or multiple candidates are presented in the user-generated content section. It can also be the case, that where the user-generated content section space is limited to, for example, two or three facts, depending on the user dwell on the search engine results page (SERP), the top ranked set of facts can be rotated through the section space according to a preconfigured rate (e.g., a new fact content once per two seconds).

At 710, candidate content of the user-generated content and the other related user-generated content is selected for presentation with a subsequent search result related to the entity. Once the user-generated content has been validated, it becomes part of the pool of content selectable as a candidate for presentation in subsequent searches related to the entity.

The method can further comprise offering a reward for submitting validated user-generated content, if the user-generated content is published. Thus, the user can choose to participate in the “rewards” program, or not to participate. Additionally, as the user becomes a trusted user for content input, the rewards can be increased to further entice the user to continue to provide reliable content input. The rewards program can further be implemented to elevate the user through increasing levels of trust, for example, based on a continuous trustworthy and validated input resulting in an “expert” or “oracle” level where the all information the user inputs is highly likely to be correct.

The method can further comprise filtering out unwanted content and unwanted users. As previously described, the filtering can be solely based on the user identity, where the user over time has too frequently provided information that has not survived the validation process. This includes spam information whether provided by the user or not. The filtering can be applied to specific categories of content input. For example, the user may usually pass validation for textual content, but too often fail validation for image content. This filtering effect can be implemented by not presenting the control (“Submit a Fact”) for selection by the user to enter user input.

The method can further comprise selecting top user-generated content for presentation. It is to be appreciated that the content selected for presentation can be based on the user geographical location. For example, if, as detected by a user device geolocation subsystem (e.g., geographical location coordinates subsystem), the user is at or near a popular geographical site, the facts presented to the user can be selected to be related to the geographical site.

The method can further comprise collapsing the content submission form from view after submission of the user-generated content. The content submission module serves only to enable user input of the desired information. Once the input process has completed, the module can be collapsed (removed) to allow other facts or other previously related search content to be presented once again.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

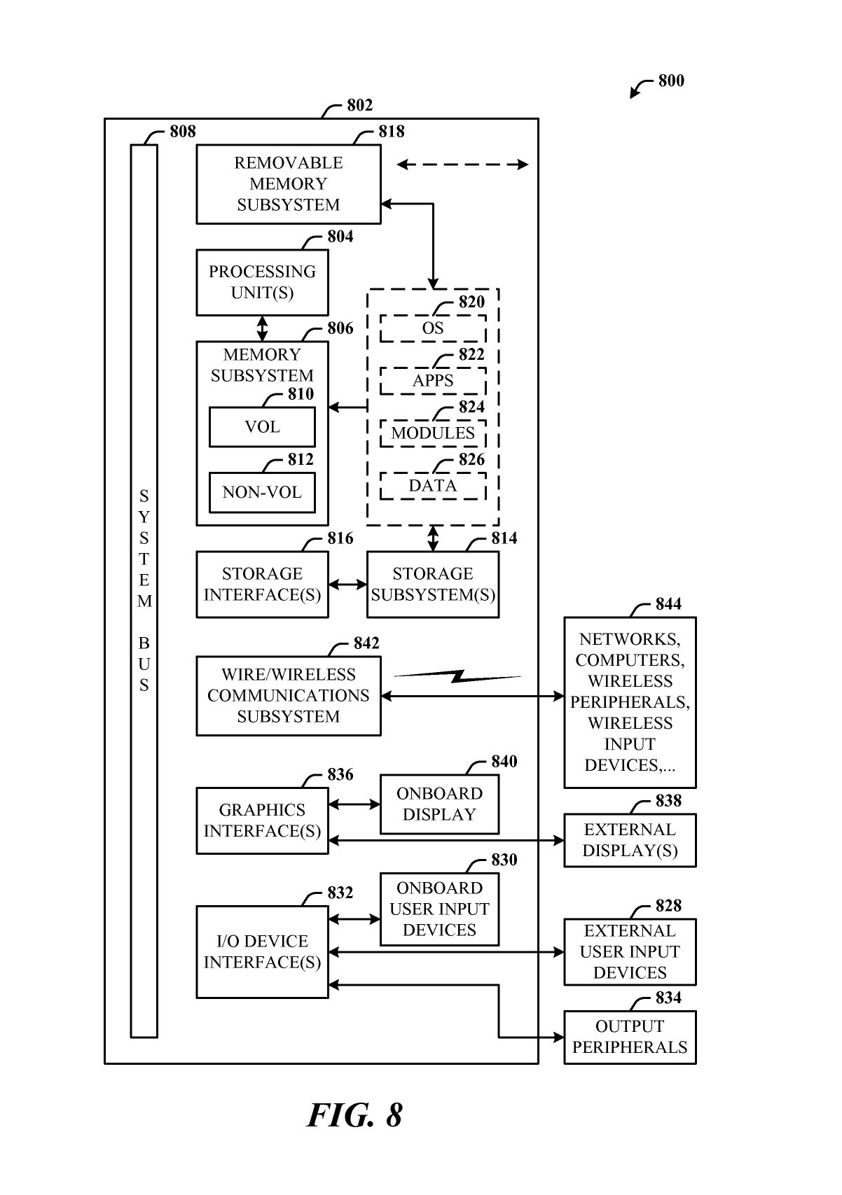

Referring now to FIG. 8, there is illustrated a block diagram of a computing system 800 that executes user-generated content on entity-specific search in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804 (also referred to as microprocessor(s) and processor(s)), a computer-readable storage medium such as a system memory 806 (computer readable storage medium/media also include magnetic disks, optical disks, solid state drives, external memory systems, and flash memory drives), and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 802 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 806 can include computer-readable storage (physical storage) medium such as a volatile (VOL) memory 810 (e.g., random access memory (RAM)) and a non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The operating system 820, one or more application programs 822, other program modules 824, and/or program data 826 can include entities and components of the system 100 of FIG. 1, entities and components of the system 200 of FIG. 2, entities of the data workflow diagram 300 of FIG. 3, entities of the user workflow diagram 400 of FIG. 4, the content submission form 414 of FIG. 5, and the methods represented by the flowcharts of FIGS. 6 and 7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 802, and include volatile and non-volatile internal and/or external media that is removable and/or non-removable. For the computer 802, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 802, programs, and data using external user input devices 828 such as a keyboard and a mouse, as well as by voice commands facilitated by speech recognition. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example.

These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a content module presented in association with a search result of a search results page, the content module presents other user-generated content related to a search entity;
a content submission component associated with the content module that enables input of user-generated content related to the search entity; and
a microprocessor that executes computer-executable instructions associated with at least one of the content module component or the content submission component.

2. The system of claim 1, further comprising a validation component that validates the user-generated content as to correctness submitted via the content submission component.

3. The system of claim 2, wherein the validated user-generated content is stored in a verified data store for access and presentation in association with a search result of another search result page.

4. The system of claim 2, wherein the validation component validates the user-generated content based on at least one of algorithmic validation, editorial input, or crowd-based input.

5. The system of claim 2, wherein the validation component enables the users to mark a fact as inaccurate, offensive, or outdated.

6. The system of claim 1, further comprising a prioritization component that prioritizes candidate user-generated content according to prioritization criteria for presentation in the content module.

7. The system of claim 1, further comprising a filter component that filters the user-generated content to process for correctness and unwanted content and spam.

8. The system of claim 1, further comprising a rewards component that applies rewards related to user-generated content that is published, the rewards component associated with a rewards provider.

9. A method, comprising acts of:
receiving a search result in a results page based on an entity;
presenting a content submission form in the results page in visual association with the search result;
receiving user-generated content related to the entity via the content submission form; and
storing the user-generated content with other related user-generated content of other users.

10. The method of claim 9, further comprising validating correctness of the user-generated content.

11. The method of claim 9, further comprising presenting the user-generated content in association with the entity based on another search for that entity.

12. The method of claim 9, further comprising ranking the user-generated content and other user-generated content for selection and presentation.

13. The method of claim 9, further comprising augmenting an entity graph with the user-generated content.

14. The method of claim 9, further comprising filtering out unwanted content.

15. The method of claim 9, further comprising offering an enticement to enter the user-generated content and acting on the enticement based on validation of the user-generated content.

16. A computer-readable medium comprising computer-executable instructions that when executed by a processor, cause the processor to perform acts of:
receiving a search result in a results page based on an entity;
presenting a content submission form in a user-generated content module in the results page in visual association with the search result in response to interaction by a user;
receiving user-generated content of the user related to the entity via the content submission form;
validating correctness of the user-generated content;
storing the user-generated content with other user-generated content related to the entity; and
selecting candidate content of the user-generated content and the other related user-generated content for presentation with a subsequent search result related to the entity.

17. The computer-readable medium of claim 16, further comprising offering a reward for submitting validated user-generated content, if the user-generated content is published.

18. The computer-readable medium of claim 16, further comprising filtering out unwanted content and unwanted users.

19. The computer-readable medium of claim 16, further comprising selecting top user-generated content for presentation.

20. The computer-readable medium of claim 16, further comprising collapsing the content submission form from view after submission of the user-generated content.
